(19) United States
(12) Patent Application Publication
(10) Pub. No.: US 2009/0115186 A1
(43) Pub. Date: May 7, 2009

(54) DELIVERY PIPE FOR TRANSPORTING SOLID MATERIAL

(75) Inventor: Alexander Esser, Warstein (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: ESSER-WERKE KG, 59581 Warstein (DE)

(21) Appl. No.: 11/577,842

(22) PCT Filed: Oct. 18, 2005
(86) PCT No.: PCT/EP05/11183

§ 371 Date: Apr. 24, 2007

(30) Foreign Application Priority Data
Oct. 28, 2004 (EP) 04025599.4

(51) Int. Cl. F16L 9/14

(52) U.S. Cl. 285/55

(57) ABSTRACT

A delivery pipe (1) for the transport of solid material includes a tubular body (2) comprised of an inner pipe (3) and an outer pipe (4). A coupling collar (7) is fixed to the outer surface (8) of the outer pipe (4) by adhesion at each pipe end (5, 6) of the tubular body (2). The coupling collar (7) includes a radially inwardly oriented circumferential shoulder (12) on its terminal end (11), with the inner diameter (Dki) of the collar sized smaller than the outer diameter (Dra) of the tubular body (2). This enables a stable adhesive securement of the coupling collar (7) to a pipe end (5, 6). At its collar end (17) distal to its terminal end (11), the coupling collar (7) has a circumferential slanted surface (18) which expands from its inner circumferential area to the outside, with a slanted surface formed underneath for accumulation of an adhesive bead (20).

The invention relates to a delivery pipe for the transport of solid material, with a tubular body, wherein a coupling collar is fixed by adhesion to each end of the tubular body.

Delivery pipes for the hydraulic or pneumatic transport of solid material, like, e.g., sand, pebbles, or concrete, have at least on the inside a hardened surface to provide a highest possible wear resistance to the normally very abrasive solids.

In order to be able to connect the delivery pipes to a pipeline and to enable an exchange of individual delivery pipes from the otherwise closed pipeline, the delivery pipes are equipped on each end thereof with coupling collars. The coupling collars are normally welded to the ends of the tubular body to ensure a tension-proof connection. As a consequence of the heat impact, welding always leads to an unsatisfactory hardness or disadvantageous changes in structure at least in the connection zone, regardless whether single-layer or double-layer delivery pipes are involved and whether the delivery pipes are hardened prior to welding o the coupling collars or after welding. For that reason, the tubular bodies are water-cooled on the inside as the coupling collars are welded on.

DE 40 10 556 A1 discloses a double-layer pipe bend which includes an inner pipe and an outer pipe. Provided in front of the pipe end and welded to the outer ring is a coupling ring which includes an inner wearing ring. The coupling ring has a short axial portion to extend over the outer pipe.

To prevent the disadvantageous heat impacts as a result of a welding operation, DE 196 07 871 C2 discloses to glue the coupling collars with the pipe ends of single-layer delivery pipes. This procedure has not proven successful in practice because such delivery pipes showed again and again damage in the area of the glue connection and leakage. The reason for that are tolerance differences between the tubular bodies and the coupling collars as well as the quality of the glue connection. The damaged delivery pipes have to be replaced, causing operational downtimes and a generally shorter service live.

Starting from this prior art, the invention is based on the object to provide a delivery pipe which is improved as far as manufacture and practical use are concerned and yet has a long service life.

This object is attained in accordance with the invention by a delivery pipe according to the features of claim 1.

The essence of the invention resides in the measure to secure the coupling collars by adhesion in a double-layer pipe comprised of an inner pipe and an outer pipe, with the coupling collar having an end face formed with a radially inwardly directed circumferential shoulder defined by an inner diameter which is smaller than the outer diameter of the tubular body. Preferably, the inner diameter of the shoulder corresponds to the inner diameter of the tubular body so as to establish a flush end at the pipe ends of a delivery pipe. Furthermore, the coupling collar includes at the forward end which is distal to its front end a free space at its inner circumferential surface. In this way, the glue connection between coupling collar and the end of the tubular body is improved.

It has been surprisingly found that the coupling collars of double-layer pipes can be secured by adhesion and results in practical benefits, even though inner pipe and outer pipe have not been interconnected by a material union. This idea has previously been discarded because “breathing” has been experienced between inner and outer pipes during operation of the delivery pipe, causing fluctuating bending stress as a result of which the longevity of the glue connection was considered unsuitable for practice. The invention overcomes this bias by using a coupling collar which is secured by adhesion and mutually supports inner and outer pipes with a radially inwardly directed circumferential shoulder on the end face. In this way, a securement by adhesion of the coupling collars to double-layer pipes becomes possible so that the advantages of a double-layer pipe can be exploited.

The delivery pipe is made of a highly wear-resistant hardened inner pipe and a pressure-resistant outer pipe. The inner pipe is intended to provide a longest possible wear resistance to the solid material being transported. Compared to the inner pipe, the outer pipe is softer and less impact-resistant. This is advantageous in particular with respect to the transport as well as assembly and disassembly because the delivery pipes are typically subjected to rough handling.

The manufacture of delivery pipes is efficient and cost-saving. Bonding between coupling collar and the outer surface of the outer pipe is realized across part of the surface or across the entire surface and is tension-proof. The shoulder at the end face forms a stop as the coupling collars are mounted over the ends of the tubular body. Preferably, a multicomponent adhesive which hardens aerobically is used. Securement by adhesion of the coupling collars without heat impact eliminates disadvantageous changes in structure, hardness jumps, or brittleness in the material of the delivery pipe. The need for additional cooling operations, as necessary when the coupling collars are secured by welding, can be omitted. Stress distribution in the area of the jointed connection is uniform. Overall, operating downtimes are reduced and the service life of the delivery pipe or of a pipeline composed of delivery pipes according to the invention is enhanced.

Advantageous configurations and further improvements of the delivery pipe according to the invention are the subject matter of the dependent claims 2 to 6.

The outer pipe assumes the function of an envelope for protection against shock and impact. As a consequence, it is sufficient to configure the outer pipe thin-walled. As the connection of the coupling collars with the outer pipe is realized in the absence of any disadvantageous thermal influences and the entire width of the coupling collars is available as jointing area, it is possible to configure the outer pipe with thinner walls in comparison to conventional designs. Basically, the ratio of the wall thickness of the inner pipe to the wall thickness of the outer pipe can be dimensioned within the scope of the invention at a ratio between 3.5:1 to 1.25:1.

The use of wearing rings anteriorly of the ends of the tubular body is generally considered advantageous within the scope of the invention. The wearing rings are made of wear-resistant and shock-resistant material, for example of a ceramic wear-resistant material, cast chromium carbide, martensitic chill nickel casting, or similar wear-resistant material.

Both pipe ends of a delivery pipe are normally provided with a wearing ring. The wearing ring is respectively placed anteriorly of the end face of a tubular body. The coupling collar embraces hereby the wearing ring, with the end face of the shoulder of the coupling collar bearing upon the wearing ring. The wall thickness of the wearing ring corresponds to the wall thickness of the tubular body so that the wearing ring ends flush with the tubular body. The same situation applies suitably with the shoulder of the coupling collar.

The free space at the collar end is preferably configured conically or funnel-shaped. The inner collar end is hereby provided with a slanted surface which expands from the inner circumferential surface of the coupling collar to the outside. The free space facilitates the placement of the coupling collar when glued to the end of the tubular body. In particular, it is advantageous that the adhesive is able to slide or is drawn into the jointing gap between the coupling collar and the outer surface of the outer pipe as a consequence of the slanted surface with its funnel-shaped contour. A sharp edge which could shear off the adhesive is avoided. Furthermore, an adhesive bead accumulates in the free space between the slanted surface and the outer surface of the outer pipe, causing additional adhesive effect and sealing.

According to a further advantageous configuration of the invention, the coupling collar has a first length section at one end face and a second section, which is distal to the shoulder and points in the direction of the pipe center, with a coupling groove disposed in-between. The thickness of the first length section is hereby sized smaller than the thickness of the second length section. This ensures a gentle treatment of the pipe ends during transport and handling of the delivery pipes, when the latter are stacked or deposited.

According to a further configuration, a seal is arranged anteriorly of the end of the tubular body for sealing the jointing gap between the tubular body and the coupling collar. The seal prevents an undermining of the glued coupling collar by transport fluid under pressure during operation. The seal may be implemented as a sealing ring or a sealing layer of suitable sealing material, for example rubber or an elastomer, and is incorporated in the union of tubular body and coupling collar in a force-transmitting and tight manner. Basically, a seal may be arranged between the pipe end and the shoulder of the coupling collar as well as between the wearing ring and the pipe end and between the shoulder and the wearing ring.

Exemplified embodiments of the invention will now be described in greater detail. It is shown in:

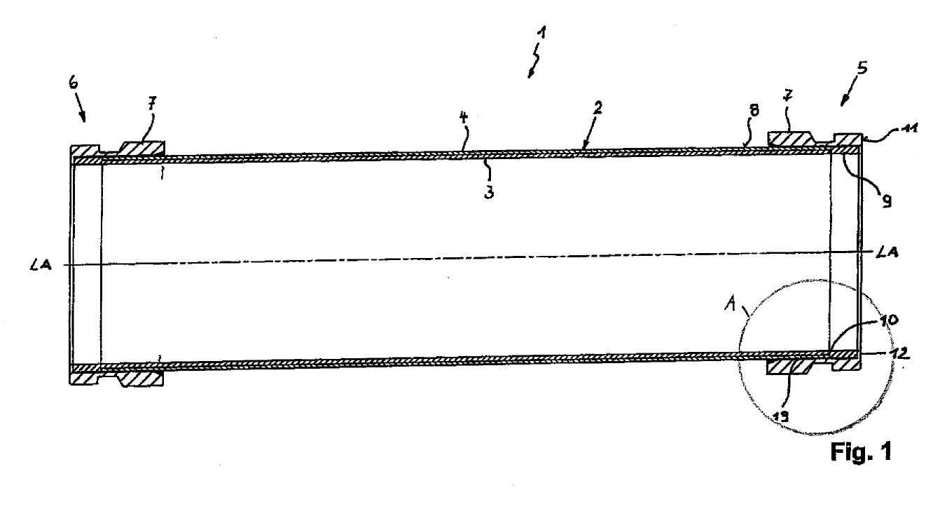

FIG. 1 a longitudinal section of a first embodiment of a delivery pipe according to the invention;

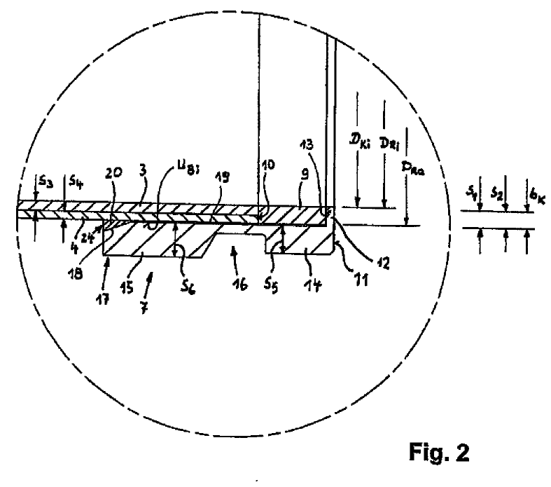

FIG. 2 an enlarged illustration of the area A of FIG. 1;

FIG. 3 a sectional view of an end portion of a second embodiment of a delivery pipe;

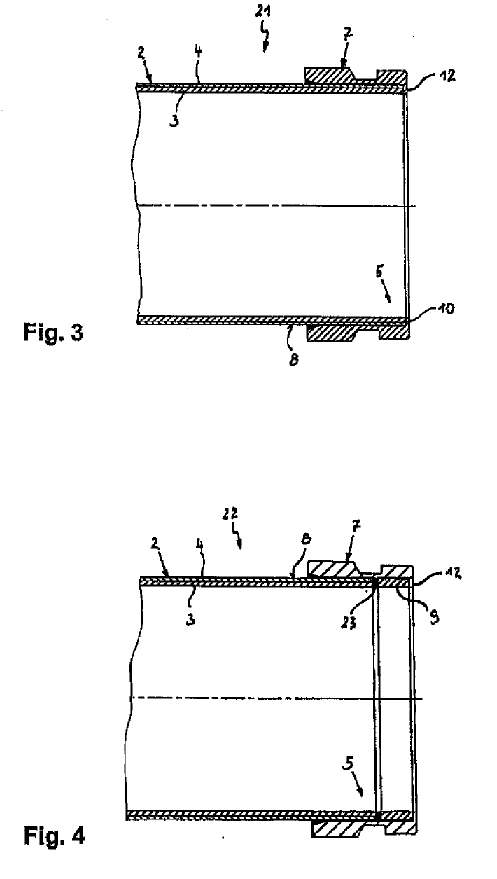

FIG. 4 a sectional view of an end portion of a third embodiment of a delivery pipe; and

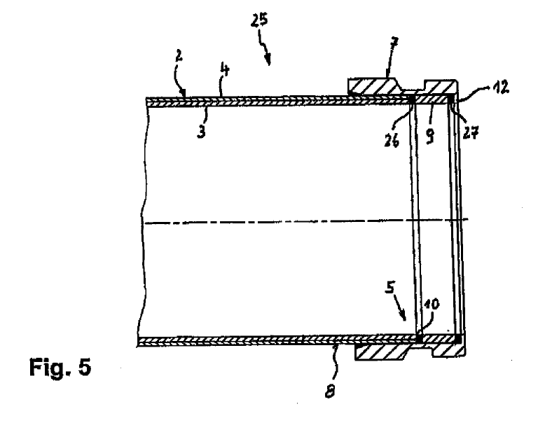

FIG. 5 a sectional view of an end portion of a fourth embodiment of a delivery pipe.

FIG. 1 shows a delivery pipe with a double-layer tubular body 2 which is comprised of a highly wear-resistant hardened inner pipe 3 and a pressure-resistant outer pipe 4.

A coupling collar 7 is secured to the outer surface 8 of the outer pipe 4 at each pipe end 5 and 6 of the tubular body 2 by way of adhesion, with inclusion of a wearing ring 9. The wearing ring 9 is placed in front of the end face 10 of the pipe ends 5 and 6. The wall thickness s₁ of the wearing ring 9 corresponds to the all thickness s₂ of the tubular body 2, with the wall thickness s₂ composed of the wall thickness s₃ of the inner pipe 3 and the wall thickness s₄ of the outer pipe 4. The wearing ring 9 extends thus flush with the tubular body 2, with the coupling collar 7 placed in surrounding relationship thereto.

Provided on the end face 11 of the coupling collar 7 is a radially inwardly directed circumferential shoulder 12. The inner diameter D_{Ki} of the shoulder 12 is sized smaller than the outer diameter D_{Ra} of the tubular body 2 and corresponds to its inner diameter D_{Ri}. The width b_{K} of the shoulder 12 is thus the same as the wall thickness s₁ of the wearing ring 8 and the wall thickness s₂ of the tubular body 2.

The coupling collar 7 is slipped with interposition of the wearing ring 9 onto the pipe ends 5 and 6 until the shoulder 12 rests upon the end face 13 of the wearing ring 9 and the wearing ring 9 presses against the pipe end 5, 6.

Unillustrated clamps engaging over the coupling collars 7 are used for producing a pipeline by linking members of delivery pipes 1.

As viewed in longitudinal pipe axis LA, the coupling collar 7 includes a terminal 1^{st} length section 14 and a 2^{nd} length section 15 pointing in the direction of the pipe center, with a coupling groove 16 disposed in-between. The wall thickness s₅ of the 1^{st} collar section 14 is hereby sized smaller than the wall thickness s₆ of the 2^{nd} collar section 15.

As can be seen in particular by the illustration of FIG. 2, on its collar end 17 distal to the end face 11, the coupling collar 7 has a circumferential slanted surface 18 which expands from its inner circumferential area U_{Bi} to the outside so that a free space 24 is defined at the collar end 17. The free space 24 simplifies the placement of the coupling collar 7 onto a pipe end 5 or 6. At the same time, the adhesive applied upon the pipe end 5, 6 is pressed and distributed into the jointing gap 19 between the inner circumferential area U_{Bi} of the coupling collar 7 and the outer surface 8 of the ends 5, 6. As a result, a tension-proof glue connection is ensured. Shearing off of adhesive is avoided. Moreover, an adhesive bead 20 is formed through accumulation in the free space 24 between the slanted surface 18 and the surface 8 of the tubular body 5, 6 for providing additional adhesion and sealing action.

The delivery pipe 21 as illustrated in FIG. 3 corresponds basically to the afore-described embodiment as far as the double-layer construction is concerned so that same reference signs are used for corresponding parts. The difference resides in the absence of a wearing ring so that the coupling collar 7 rests with its shoulder 12 upon the end face 10 of the tubular body 2 and is glued across the entire surface with the outer surface 8 of the outer pipe 4.

The delivery pipe 22 shown in FIG. 4 has incorporated therein a seal 23 between the end face 10 of the tubular body 2 and the wearing ring 9. Otherwise the delivery pipe 22 corresponds to the configuration of the delivery pipe 1. The seal 23 additionally seals the jointing gap 19 between the tubular body 2 and the coupling collar 2 so that fluid is prevented from escaping via the jointing gap 19.

A seal 26 is integrated in the embodiment of a delivery pipe 25 between the end face 10 of the tubular body 2 and the wearing ring 9, and a seal 27 is integrated between the wearing ring 9 and the shoulder 12. The remaining structure of the delivery pipe 25 corresponds to the afore-described one.

As a result of the securement of the coupling collar 7 by adhesion with the outer surface 8 of the outer pipe 4 and the radially inwardly directed circumferential shoulder 12, a tension-proof connection with long fatigue strength is realized without thermal connection. As a result, the wall thickness s₄ of the outer pipe 4 can be sized smaller than to date. Therefore, the wall thickness s₃ of the inner pipe can be increased. Basically, it can be noted that the ratio of the wall thickness s₃ of the inner pipe to the wall thickness s₄ of the outer pipe 4 ranges between 3.5:1 to 1.25:1.

### LIST OF REFERENCE SIGNS

1—delivery pipe
2—tubular body
3—inner pipe
4—outer pipe
5—pipe end of 2
6—pipe end of 2
7—coupling collar
8—outer surface of 4
9—wearing ring
10—end face of 5, 6
11—end face of 7
12—shoulder
13—end face of 9
14—1^{st} length section
15—2^{nd} length section
16—coupling groove
17—collar end of 7
18—slanted surface
19—jointing gap
20—bead
21—delivery pipe
22—delivery pipe
23—seal
24—free space
25—delivery pipe
26—seal
27—seal
LA—longitudinal pipe axis
D_{Ki}—inner diameter of 12
D_{Ra}—outer diameter of 2
D_{Ri}—inner diameter of 2
s₁—wall thickness of 9
s₂—wall thickness of 2
s₃—wall thickness of 3
s₄—wall thickness of 4
s₅—wall thickness of 14
s₆—wall thickness of 15
B_{K}—width of 12
U_{Bi}—inner circumferential area of 7

1-5. (canceled)

6. A delivery pipe for the transport of solid material, comprising:
a tubular body comprised of an inner pipe and an outer pipe;
a coupling collar secured by adhesion to an outer surface of the outer pipe, said coupling collar having an end face which includes a radially inwardly directed circumferential shoulder of an inner diameter which is smaller than an outer diameter of the tubular body, said coupling collar having an inner circumferential area configured to define a free space in a region of a forward end that is distal to the end face; and
a sealing member disposed anteriorly of the tubular body.

7. The delivery pipe of claim 6, wherein the sealing member is a sealing ring.

8. The delivery pipe of claim 6, wherein the sealing member is a sealing layer.

9. The delivery pipe of claim 6, further comprising a wearing ring disposed between the shoulder and an end face of the tubular body.

10. The delivery pipe of claim 9, wherein the wearing ring is defined by a wall thickness which corresponds to a wall thickness of the tubular body.

11. The delivery pipe of claim 6, wherein the coupling collar has a terminal first length section, a second length section which extends in a direction towards midsection of the tubular body, and a coupling groove extending between the first and second length sections, wherein the first length section has thickness which is smaller than a thickness of the second length section.

12. The delivery pipe of claim 6, wherein the inner pipe has a wall thickness and the outer pipe has a wall thickness, wherein a ratio of the wall thickness of the inner pipe to the wall thickness of the outer pipe ranges between 3.5:1 to 1.25:1.
